(19) United States
(12) Patent Application Publication
(10) Pub. No.: US 2011/0166943 A1
(43) Pub. Date: Jul. 7, 2011

(54) POLICY-BASED ADVERTISEMENT ENGINE

(75) Inventor: Stephane H. Maes, Fremont, CA (US)

(73) Assignee: Oracle International Corporation, Redwood Shores, CA (US)

(21) Appl. No.: 12/986,432

(22) Filed: Jan. 7, 2011

Related U.S. Application Data
(60) Provisional application No. 61/293,154, filed on Jan. 7, 2010.

(51) Int. Cl. G06Q 30/00

(52) U.S. Cl. 705/14.73; 705/14.4

(57) ABSTRACT

Embodiments of the invention provide methods and systems for enforcing policy-based advertisements . The method includes receiving a service request from a requestor, intercepting by a policy enforcer, and presenting an advertisement offer, including an advertisement, wherein the advertisement offer includes an associated reduced rate offer for the requested service. The method further includes presenting the advertisement to the requestor in response to accepting the advertisement offer, verifying that the requestor has received, viewed, and/or listened to the advertisement, and presenting the requested service at the associated reduced rate.

### PRIORITY CLAIM

The application claims priority to Provisional Application No. 61/293,154 filed on Jan. 7, 2010, entitled POLICY-BASED ADVERTISEMENT ENGINE, which is incorporated by reference in its entirety for any and all purposes.

### BACKGROUND OF THE INVENTION

Embodiments of the present invention relate generally to methods and systems for presenting advertisements and, more particularly, to enforcing policy-based advertisements.

Presently, advertisements are statically presented to users of various services. For example, a user may visit a webpage and a variety of advertisement banners and/or pop-ups may be presented to the user. Alternatively, a user may listen to an advertisement while waiting for a recipient of a telephone call to answer, or the user may view an advertisement before watching a streaming video. However, in each of these situations, the advertisements are statically presented to the user, and additionally, the advertisements are integrated into the service being provided to the user (i.e., the video stream, the telephone call, the webpage, etc.) Hence, there is a need for improvements in the art.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high level, functional components of a system for enforcing policy-based advertisements according to one embodiment of the present invention.

FIG. 4 is a flowchart illustrating a process for enforcing policy-based advertisements according to one embodiment of the present invention.

FIG. 5 is a flowchart illustrating a process for enforcing policy-based advertisements according to an alternative embodiment of the present invention.

FIG. 6 is a flowchart illustrating a process for enforcing policy-based advertisements according to yet another embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to, portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc.

may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Methods for enforcing policy-based advertisements are described. For example, a service request (e.g., a webpage request, a short message service (SMS) text request, a voice telephone call request, a video request, etc.) may be intercepted by a policy enforcement mechanism. This policy enforcement mechanism may intercept the service request and check if usage policies have been satisfied (e.g., authentication, authorization, subscription, etc.). The policy enforcement mechanism may further check if an advertisement should be presented to the user, and if so, what type of advertisement over what type of medium.

Accordingly, the policy enforcement mechanism may then dynamically present an advertisement(s) adapted to the medium channel and the user. Furthermore, the advertisement may allow the user to receive the desired service at a reduced fee or rate. Accordingly, once the advertisement has been accepted and/or received by the user, the service is then presented to the user. Various additional details of embodiments of the present invention will be described below with reference to the figures.

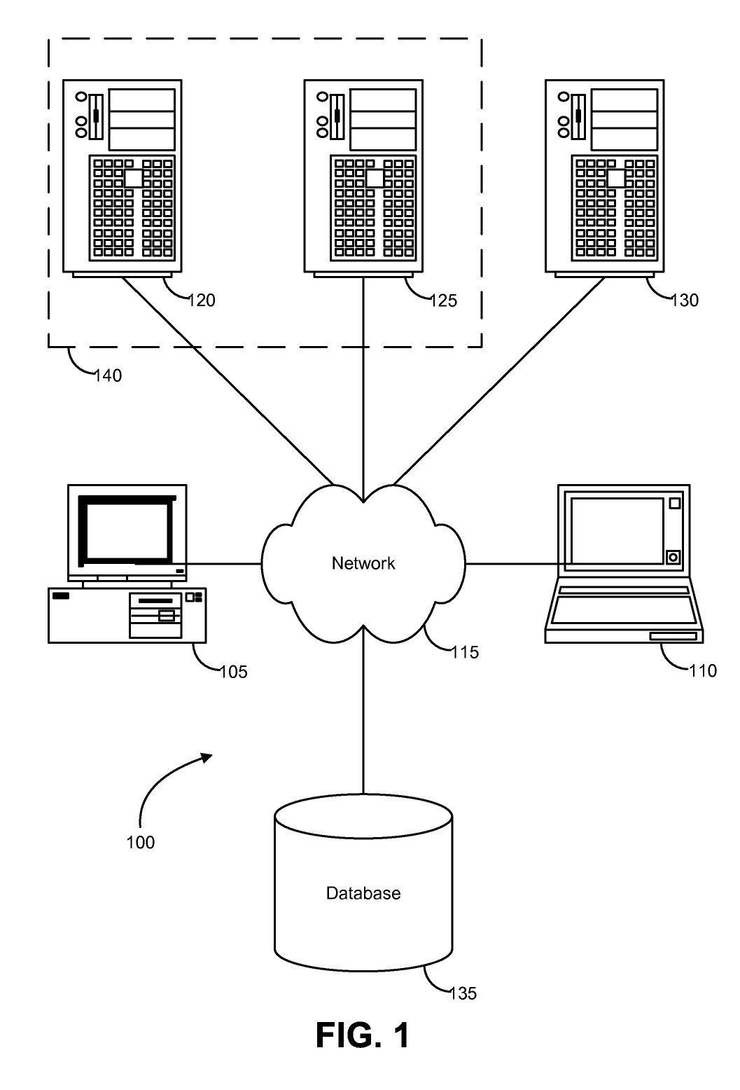

FIG. 1 is a block diagram illustrating components of an exemplary operating environment in which various embodiments of the present invention may be implemented. The system 100 can include one or more user computers 105, 110, which may be used to operate a client, a dedicated application, a web browser, etc. The user computers 105, 110 can be general purpose personal computers (including, merely by way of example, personal computers and/or laptop computers running various versions of Microsoft® Corp.'s Windows® and/or Apple Corp.'s Macintosh® operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents.

Although the exemplary system 100 is shown with two user computers, any number of user computers may be supported.

In some embodiments, the system 100 may also include a network 115. The network 115 can be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network (“WAN”); a virtual network, including without limitation, a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO, etc.

The system 100 may also include one or more server computers 120, 125, 130 which can be general purpose computers and/or specialized server computers (including, merely by way of example, PC servers, UNIX servers, mid-range servers, mainframe computers rack-mounted servers, etc.), personal digital assistants (PDAs), and other such computing devices. One or more of the servers (e.g., 130) may be dedicated to running applications, such as a business application, a web server, an application server, etc. Such servers may be used to process requests from user computers 105, 110. The applications can also include any number of applications for controlling access to resources of the servers 120, 125, 130.

The web server 140 can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation, those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from user computers 105, 110 and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 120, 125, 130. Alternatively, it may be remote from any or all of the computers 105, 110, 120, 125, 130, and/or in communication (e.g., via the network 115) with one or more of these. In a particular set of embodiments, the database 135 may reside in a storage-area network (“SAN”) familiar to those skilled in the art. Similarly, any necessary files for performing the functions attributed to the computers 105, 110, 120, 125, 130 may be stored locally on the respective computer and/or remotely, as appropriate. In one set of embodiments, the database 135 may be a relational database, such as Oracle® 10g, that is adapted to store, update, and retrieve data in response to SQL-formatted commands.

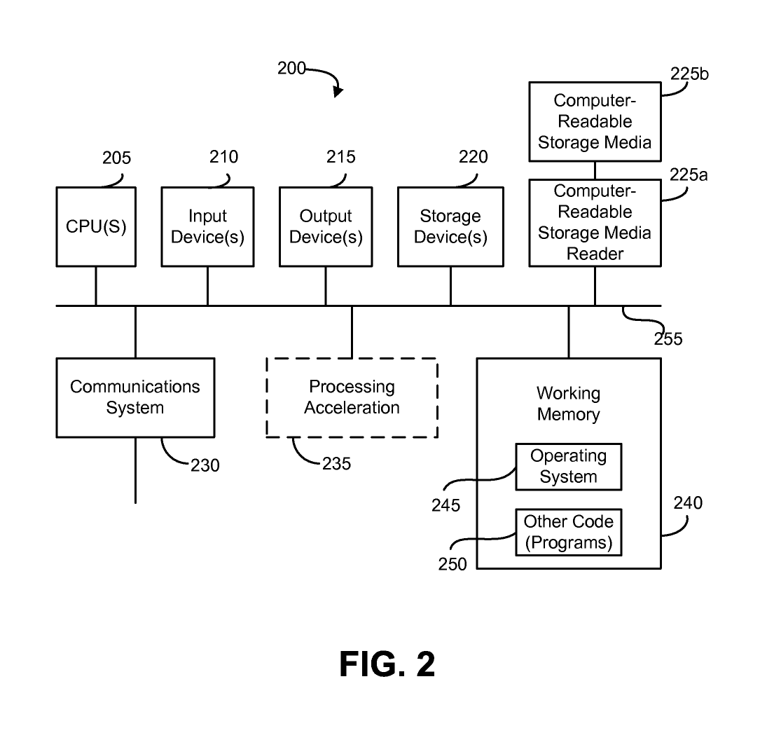

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage devices 220. By way of example, storage devices 220 may be disk drives, optical storage devices, and/or solid-state storage devices such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 115 (FIG. 1) and/or any other computer described above with respect to the system 200.

The computer system 200 may also be comprised of software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

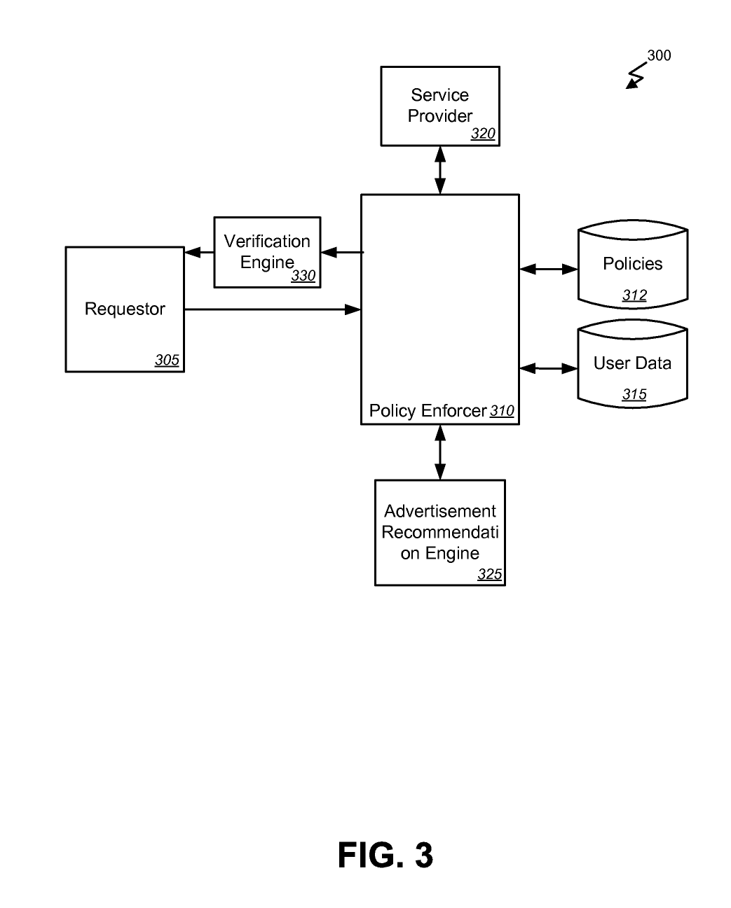

FIG. 3 is a block diagram illustrating, at a high level, functional components of a system for enforcing policy-based advertisements according to one embodiment of the present invention. In this example, the system 300 includes a requestor 305, which may be a subscriber to a service (e.g., a telecommunications service, an Internet service provider (ISP), a video-on-demand service, etc.). Requestor 305 may be a personal computer, a portable device, a cellular device, a personal digital assistant (PDA), etc., which initiates service requests. Such a service request may include a request to place a telephone call, a webpage request, an SMS text transmission request, an email transmission request, etc.

In a further embodiment, system 300 may include a policy enforcer 310, which is connected with requestor 305 via a transmission channel. As described above, the transmission channel may be any channel appropriate for transmission of the corresponding service (e.g., an Internet connection for webpage requests, a cellular connection for cellular telephone calls, etc.). Furthermore, policy enforcer 310 may be configured to intercept service requests made by requestor 305. Hence, according to one embodiment, policy enforcer 310 is configured to operate external to a service provider 320, which allows for policy enforcer 310 to interact with requestor 305 independently from service provider 315, as well as before any interaction with service provider 315.

As policy enforcer 310 intercepts the service request, policy enforcer 310 may access a policy database 312. In one embodiment, policy database 312 may include, for example, usage policies (e.g., authentication, authorization, subscription, etc.) configured to determine if requestor 305 is authorized and/or is a subscriber to the service being requested from service provider 320. In addition, policy database 312 may further include advertisement enforcement and/or advertisement configuration policies. In one embodiment, policy enforcer 310 may be implemented as a back-end/network. Further, a client may be used to make the request (e.g., a phone, PC, etc.).

For example, an advertisement enforcement policy may include instructions for handling channel-specific advertisement constraints. Such constraints may be, for example, selecting advertisements that are appropriate to the service's channel type. For example, if requestor 305 is attempting to send an SMS text, then the advisement should only include text; however, if requestor 305 is attempting to place a phone call, then the advertisement should only include audio, and so forth.

Furthermore, the policies may also include rate reduction and/or modification instructions for the requested service based on the advertisements read, listened to, viewed, etc. by requestor 305. For example, a rate reduction may indicate that if the advertisement is received, requestor 305 is able to receive the service for free, or at a reduced rate (e.g., 5 cents/mins. less, the first 5 minutes free, etc.) In addition, the policy may indicate that if requestor 305 listens to one advertisement, the rate is X per minute, and for two advertisements the rate is Y per minute, and so forth.

Alternatively, or in addition to, requestor 305 may be able to listen to the advertisement(s) before the service is received, during the service, (e.g., the first 10 minutes at a reduced rate for accepting a first advertisement, and then after accepting a second advertisement, the next 10 minutes continue to be at a reduced rate), immediately after the service, or at a later time after the service (e.g., requestor 305 may initially pay for the service, but then if the advertisement is later viewed, listened to, read etc., then requestor 305 would be credited with all or some of the charges for the service).

In a further embodiment, system 300 may include a user database 315 connected with policy enforcer 310. User database 315 may include preference and historical information about requestor 305. For example, requestor 305 may be able to configure their user preferences such that they always accept offers to listen to advertisements when making telephone calls, or they never want textual advertisements through their email or SMS text services. Any number of combinations may be used, including the number of advertisements desired, the type of advertisements desired, the media type of the advertisements desired, the frequency of advertisements, etc.

In addition to preference data, user database 315 may also include historical data. For example, based on requestor 305′s Internet browsing patterns, phone records, age, home address, marital status, employment, interests, phone record, etc., advertisements can be tailored to requestor 305′s interests. For example, if requestor 305 consistently goes to a sports teams' website in city A, makes a number of calls to city A, and travels to city A often, then advertisements directed toward sports, long distance, and travel (i.e., to and from city A), would likely be better received. Hence, through the use of policy enforcer 310, customized dynamic advertisements may be presented to requestor 305.

Alternatively, policy enforcer 310 may simply receive advertisements from an advertisement queue, and as requestor 305 agrees to accept an advertisement, policy enforcer 310 presents the next advertisement in the queue. Further, there may be a separate queue for each channel/media type, and after the channel/media type of the service being requested is determined, the advertisement would be pulled from the channel/media specific queue.

In a further embodiment, system 300 may include an advertisement recommendation engine 325 connected with policy enforcer 310. Advertisement recommendation engine 325 may receive the historical and preference data from user database 315 and channel information, and based on this information, presents advertisement recommendations. Advertisement recommendation engine 325 may then present the recommendations to policy enforcer 310, which may then offer the advertisement(s) to requestor 305.

In yet another embodiment, system 300 may include a verification engine 330 connected to both requestor 305 and policy enforcer 310. Verification engine 330 may be configured to verify that requestor 305 has received, viewed, listened, read, etc., the received advertisement(s). Accordingly, upon verification of such, verification engine 325 may then transmit an indication to policy enforcer 310. Once policy enforcer 310 has received the indication, policy enforcer 310 would allow the service to be presented to requestor 305.

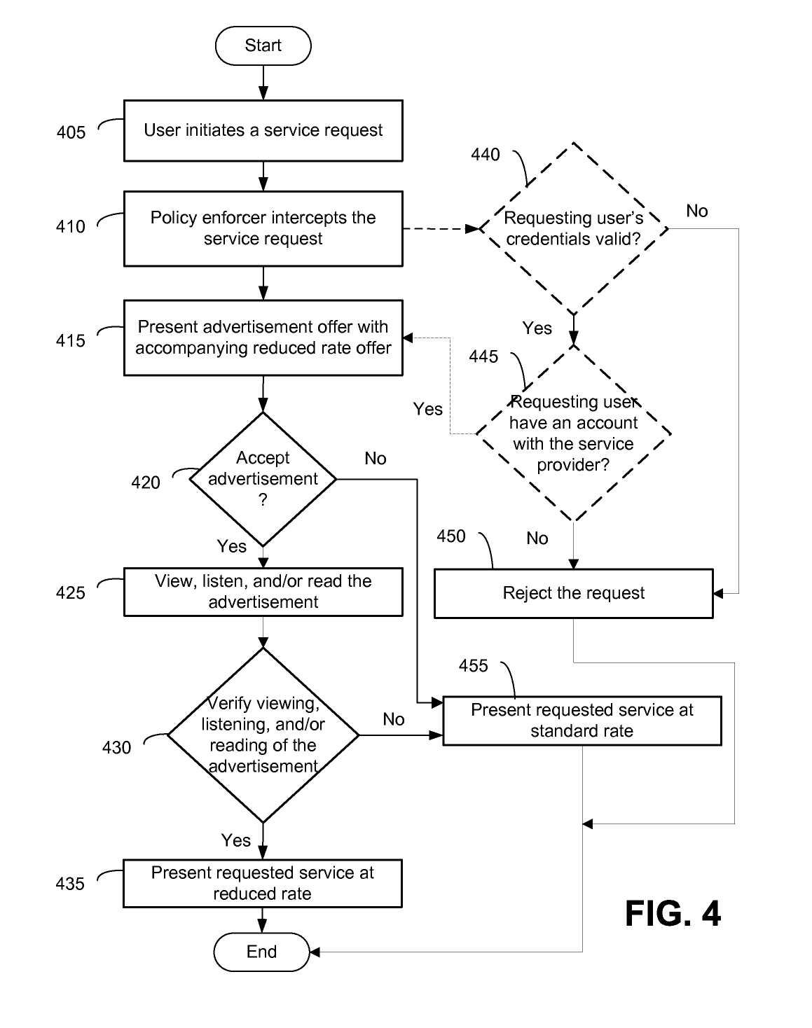

Turning now to FIG. 4 is a flowchart illustrating a process for enforcing policy-based advertisements according to one embodiment of the present invention. In this example, at process block 405, a user initiates a service request. For example, the user may attempt to place a phone call, access a webpage, send a text message, etc. At process block 410, a policy enforcer intercepts the request. In one embodiment, the policy enforcer may reside on the device initiating the request, or alternatively, may be positioned between the initiating device and the service provider.

At decision block 440, the policy enforcer may optionally determine if the requesting user's credentials are valid (e.g., authentication, authorization, etc.). If the credentials are not valid, then at process block 450, then request is rejected and the process ends. Alternatively, if the credentials are valid, the at decision block 445, a determination is made whether the requesting user has an account with the service provider for the requested service. If the user does not have an account, then at process block 450, the request is rejected and the process ends. However, if the user does have an account, then at process block 415, an advertisement offer is presented to the user.

In one embodiment, the advertisement offer may include an accompanying reduced or modified rate for the service. In other words, if the user accepts the offer to view, listen, read, etc., (depending on the media channel of the requested service) then the user would receive the service at a reduced or modified rate. At decision block 420, a determination is made whether the user has accepted the advertisement offer. If the advertisement offer is not accepted, then at process block 455, the requested service is presented to the user at the standard rate, and then the process ends.

Alternatively, is the advertisement offer is accepted, then at process block 425, the advertisement is presented to the user for viewing, listening, and/or reading. At decision block 430, it is verified that the user has read, listened, viewed, etc., the advertisement; then at process block 435, the requested service is presented to the user at the reduced/modified rate. However, if it is determined that the user did not read, listen, view, etc., the advertisement, then at process block 455, the requested service is presented at the standard rate.

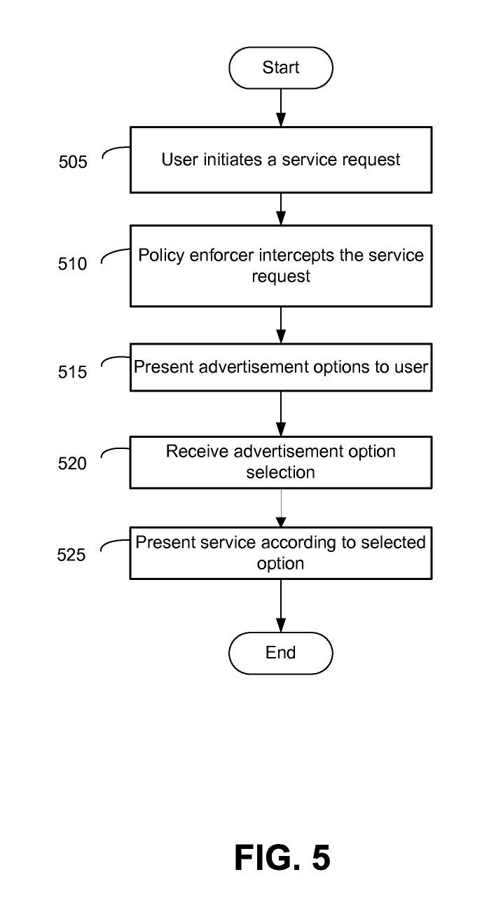

FIG. 5 is a flowchart illustrating a process for enforcing policy-based advertisements according to an alternative embodiment of the present invention. In this example, at process block 505, a user initiates a service request. For example, the user may attempt to place a phone call, access a webpage, send a text message, etc. At process block 510, a policy enforcer intercepts the request. At process block 515, the user may be presented with advertisement options. Alternatively, the user may be able to modify these options prior to initiating a service request. Nonetheless, such options may include, for example, the types of advertisements desired, the frequency of advertisements, the number of advertisements, the channels in which advisements are desired, etc.

At process block 520, the policy enforcer receives the selected options and stores them relative to the user. Accordingly, the advertisements associated with the service(s) requested by the user will be presented in accordance with the user's selected preferences (process block 525).

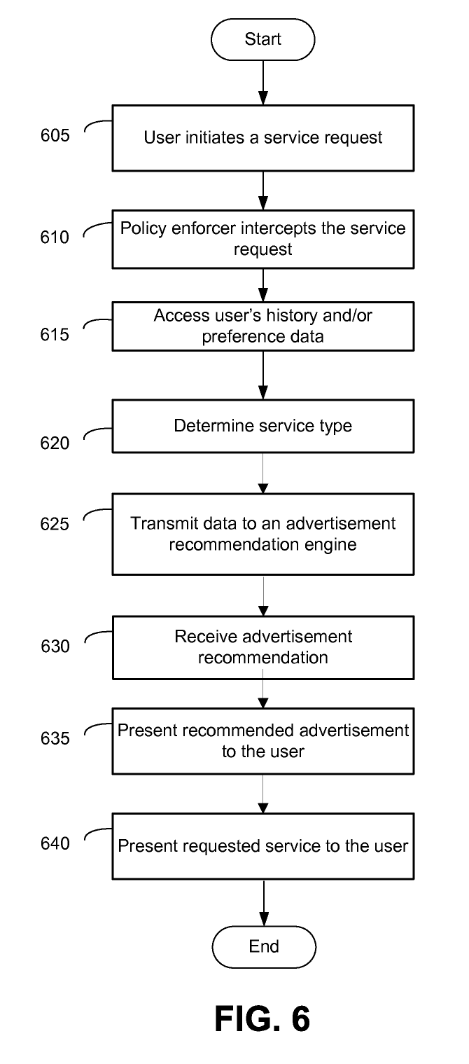

FIG. 6 is a flowchart illustrating an alternative process for enforcing policy-based advertisements according to one embodiment of the present invention. In this example, at process block 605, a user initiates a service request. For example, the user may attempt to place a phone call, access a webpage, send a text message, etc. At process block 610, a policy enforcer intercepts the request. In one embodiment, at process block 615, the user's history and/or preferences data may be accessed and the type of the requested service may be determined (process block 620).

At process block 625, the collected data is used to make customized advertisement recommendations for the user. In one embodiment, advertisements specifically targeted to the user may be recommended. The recommended advertisements are received by the policy enforcer (process block 630). Accordingly, the policy enforcer then presents the recommended advertisements to the user (process block 635), after which the user is presented with the requested service (process block 640).

In the foregoing description, for the purposes of illustration, methods were described in a particular order. It should be appreciated that, in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits, programmed with the instructions to perform the methods. These machine-executable instructions may be stored on one or more machine-readable mediums, such as CD-ROMs or other types of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of enforcing policy-based advertisements, the method comprising:
receiving a service request from a requestor;
intercepting, by a policy enforcer, the service request;
presenting an advertisement offer including an advertisement, wherein the advertisement offer includes an associated reduced rate offer for the requested service; and
presenting the advertisement to the requestor.

2. The method of claim 1, further comprising:
verifying that the requestor has received, viewed, and/or listened to the advertisement, in response to accepting the advertisement offer;
presenting the requested service at the associated reduced rate;
accessing, by the policy enforcer, a policy database, wherein the policy database includes a plurality of policies configured to enforce the advertisement offer;
selecting one of the plurality of policies; and
enforcing the policy;

3. The method of claim 1, further comprising:
requesting, by the policy enforcer, the requestor's credentials; and
determining if the credentials are valid; and
presenting the advertisement offer to the requestor, in response to the credentials being valid; and
rejecting the service request, in response to the credentials being invalid.

4. The method of claim 1, further comprising:
determining if the requester has an account with the requested service's service provider; and
presenting the requestor with the advertisement offer, in response to the requestor having an account with the service provider.

5. The method of claim 4, further comprising:
rejecting the service request, in response to the requestor not having an account with the service provider.

6. The method of claim 1, wherein the service includes one or more of the following: a short message service (SMS) text service, an email service, a voice telephone service, and a video service.

7. The method of claim 1, wherein the reduced rate offer includes one or more of the following: a reduced price per minute, a reduced overall price, a free service, and a reduced price per byte.

8. A method of enforcing policy-based advertisements, the method comprising:
receiving a service request initiated by a user;
intercepting the service request by a policy enforcer;
presenting advertisement options to the user;
receiving an advertisement option selection from the user; and
presenting the requested service to the user according to the selected advertisement option.

9. The method of claim 8, wherein the advertising options include one or more of the following: advertising frequency, advertising length, service type-based advertising, and advertising placement within the service.

10. The method of claim 8, wherein the advertising options further comprise:
providing the requested service at a first rate for a first set period of time;
presenting the advertisement to the user after the first set period of time ends; and
providing the request service at a second rate for a second set period of time, in response to the user accepting the advertisement.

11. The method of claim 8, wherein the policy enforcer is implemented on a back-end network, and a client is configured to use the back-end network to make the request.

12. A method of enforcing policy-based advertisements, the method comprising:
receiving, by a business process, a service request from a requestor;
intercepting, by a policy enforcer, the service request;
presenting an advertisement offer, including an advertisement and advertisement acceptance preferences, wherein the advertisement offer includes an associated reduced rate offer for the requested service, and the advertisement acceptance preferences include a method of acceptance preference and a time for acceptance preference;
receiving the requestor's preference selection;
presenting the advertisement according to the received preferences; and
presenting the requested service according to the reduced rate offer.

13. The method of claim 12, wherein the method of acceptance preference includes one or more of the following: accepting the advertisement through an email and/or text message, accepting the advertisement through a universal resource locator (URL) link, and accepting the advertisement directly to a portable device.

14. The method of claim 12, wherein the time for acceptance preference includes one or more of the following: accepting the advertisement before the requested service, accepting the advertisement between the start and the finish of the requested service, accepting the advertisement immediately after the requested service, and accepting the advertisement after the requested service.

15. A system for enforcing policy-based advertisements, the system comprising:
a requestor configured to request a service;
a policy database configured to store advertisement enforcement policies;
a policy enforcer coupled with the requestor and the policy database, the policy enforcer configured to intercept the service request, present an advertisement offer including an advertisement, wherein the advertisement offer includes an associated reduced rate offer for the requested service, and in response to accepting the advertisement offer, present the advertisement to the requestor; and
a service provider coupled with the policy enforcer, the service provider configured to present the requested service to the requestor at the associated reduced rate.

16. The system of claim 15, further comprising:
a user database configured to store history data and preference data for the requestor; and
an advertisement recommendation engine coupled with the user database, the advertisement recommendation engine configured to retrieve the history and preference data from the user database, and based on the user's history and preference data, determine an advertisement to present to the requestor, and transmit the recommended advertisement to the policy enforcer.

17. The system of claim 16, further comprising a validation engine coupled with the policy enforcer and the requestor, the validation engine configured to verify that the requestor has received, viewed, and/or listened to the advertisement.

18. A method of enforcing policy-based advertisements, the method comprising:
receiving, by a service, a service request initiated by a user;
intercepting the service request by a policy enforcer;
accessing the user's history and preference data;
transmitting the user's history and preference data to an advertisement recommendation engine;
determining an advertisement to present to the user, based on the user's history and preference data;
presenting the recommended advertisement to the user; and
presenting the requested service to the user, in response to the user receiving the recommended advertisement.

19. The method of claim 18, further comprising:
determining the requested service's service type; and
selecting an advertisement suitable for the service type.

20. The method of claim 19, wherein the service type includes one or more of the following: audio, video, or text.
